(19) United States
(12) Patent Application Publication
(10) Pub. No.: US 2026/0110332 A1
(43) Pub. Date: Apr. 23, 2026

(54) SEALING DEVICE

(71) Applicant: UCHIYAMA MANUFACTURING CORP., Okayama (JP)

(72) Inventor: Yuta DAIMATSU, Okayama (JP)

(21) Appl. No.: 19/354,629

(22) Filed: Oct. 9, 2025

(30) Foreign Application Priority Data
Oct. 21, 2024 (JP) 2024-184910

(51) Int. Cl. F16C 33/76

(52) U.S. Cl. CPC F16C 33/766; F16C 2326/02

(57) ABSTRACT

A sealing device including a U-shaped slinger to achieve reduction of torque and improvement of sealing ability is provided. A core member portion of the sealing device includes a seal lip portion which performs relative rotational motion while being in contact with the slinger and is made of an elastic material. The slinger includes a first cylindrical portion, a disk portion, and a second cylindrical portion, and has a recessed space as an outer frame which is defined by the first cylindrical portion, the disk portion, and the second cylindrical portion. At least two continuous faces of a first face of the disk portion and a second face of the disk portion are roughened, the first face facing the recessed space, the second face being adjacent to the first face are roughened.

### BACKGROUND OF THE INVENTION

### Field of the Invention

The present invention relates to a sealing device including a seal lip portion which is made of an elastic material and performs relative rotational motion while being in contact with a slinger.

### Description of the Related Art

As for a sealing device in which a lip piece of a seal lip portion elastically contacts (slidingly contacts) a slinger in an L shape, for achieving reduction in torque, various technologies for roughening an L-shaped inner face of the slinger with which the lip piece may be in contact have been conventionally proposed, for example, referring to Patent Document 1.

### RELATED ART DOCUMENTS

### Patent Documents

Patent Document 1: Japanese Unexamined Patent Application Publication No. 2010-78140

### SUMMARY OF THE INVENTION

### Problems to be Solved by the Invention

Meanwhile, adopting a slinger in a U shape has generally been considered appropriate for achieving improvement in sealing performance of the sealing device.

Accordingly, by adopting the slinger in the U shape and appropriately roughening a lip sliding contact surface of the slinger, both reduction in torque and improvement in sealing performance are achieved; however, such a sealing device has not been conventionally proposed.

The present invention is proposed in view of the above-mentioned problems, and an object of the present invention is to provide a sealing device which achieves both reduction in torque and improvement in sealing performance in the sealing device using the slinger in the U shape.

### Means of Solving the Problems

In order to achieve the above-mentioned object, a sealing device of one aspect of the present invention is an annular sealing device including a core member portion to be fitted and fixed to one of two members which relatively rotate in a concentric manner, and a slinger to be fitted and fixed to another of the two members. The sealing device, being configured to seal a space between the two members, is characterized in that the core member portion includes a seal lip portion which performs relative rotational motion while being contact with the slinger and is made of an elastic material, and is characterized in that the slinger includes a first cylindrical portion, a disk portion, and a second cylindrical portion which are provided for fitting, and has a recessed space as an outer frame which is defined by the first cylindrical portion, the disk portion, and the second cylindrical portion, and is further characterized in that at least two continuous faces, i.e., a first face of the disk portion and a second face of the disk portion are roughened, the first face facing the recessed space, the second face being adjacent to the first face.

### Effects of the Invention

Constituted as above, the sealing device of the present invention achieves both reduction in torque and improvement in sealing performance in a sealing device using a slinger in a U shape.

### BRIEF DESCRIPTION OF THE DRAWINGS

FIG. 1 is a schematic longitudinal sectional view of a bearing device including the sealing device according to one embodiment of the present invention.

FIG. 2A and FIG. 2B are enlarged views of an area “X” in FIG. 1 and are schematic sectional end views of the sealing device according to two types of usage modes using slingers in the same shape.

FIG. 3A and FIG. 3B are schematic partial longitudinal sectional views illustrating two modes of a projection step of a projection material to a slinger body.

FIG. 4A is a schematic sectional end view of the slinger body, and FIG. 4B, FIG. 4C, and FIG. 4D are tables showing experimental results of one embodiment of the sealing device of the present invention.

FIG. 5A to FIG. 5C are schematic sectional end views of the slinger body to be used in the sealing device according to another embodiment of the present invention.

FIG. 6A and FIG. 6B are schematic end views of the slinger body to be used in the sealing device according to further another embodiment of the present invention.

### DESCRIPTION OF THE EMBODIMENTS

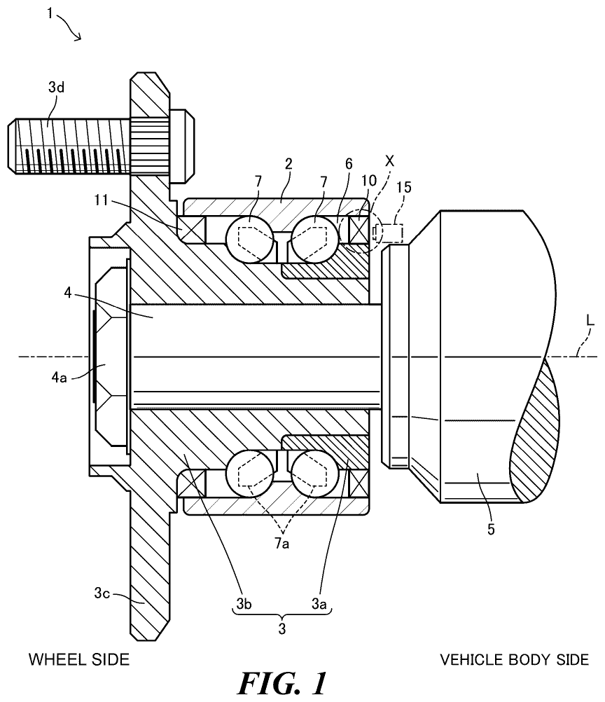

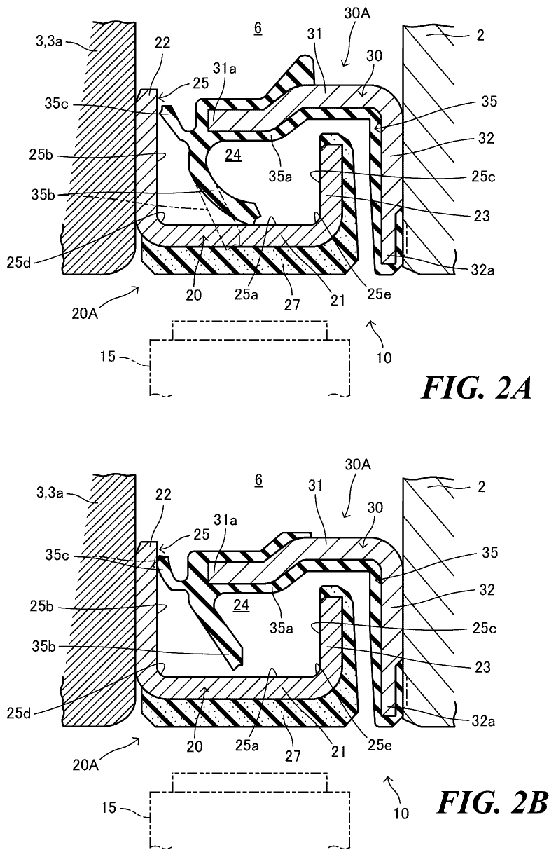

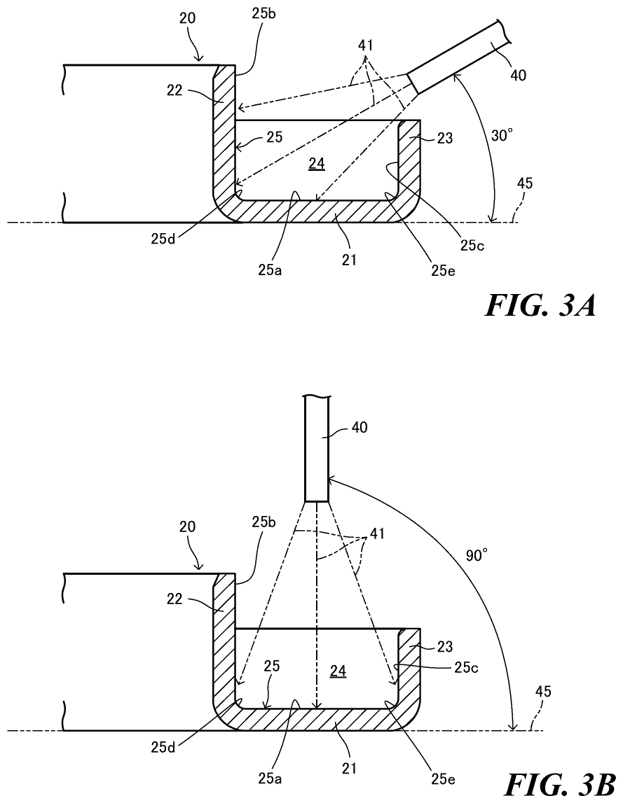

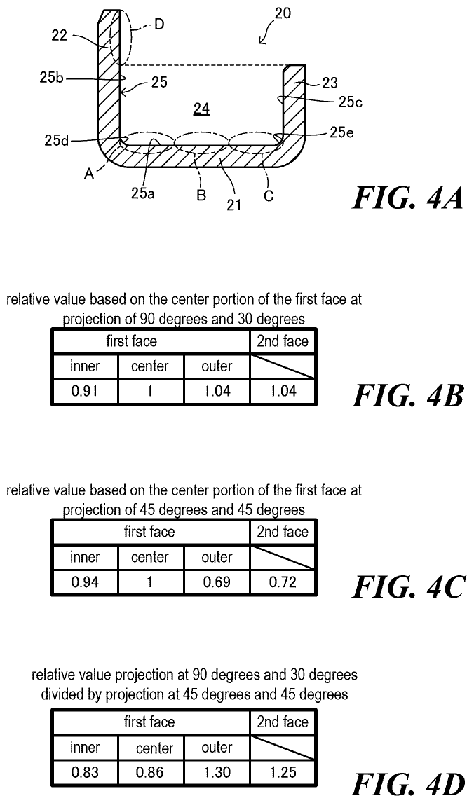

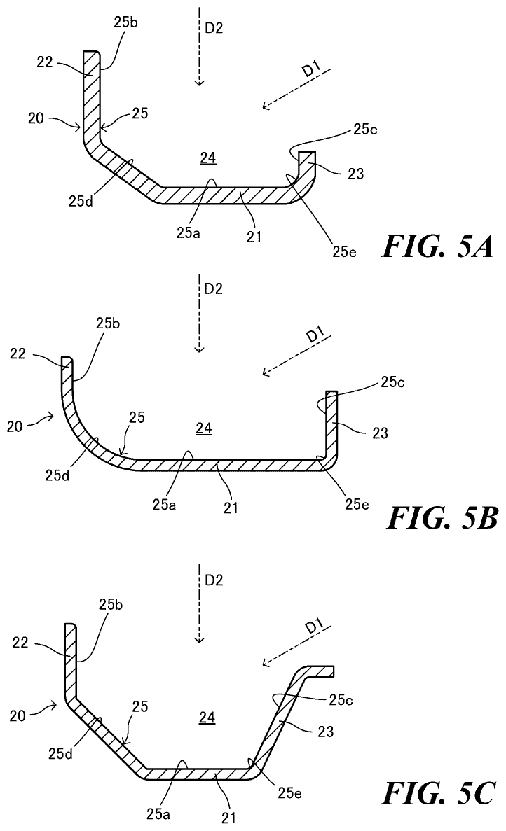

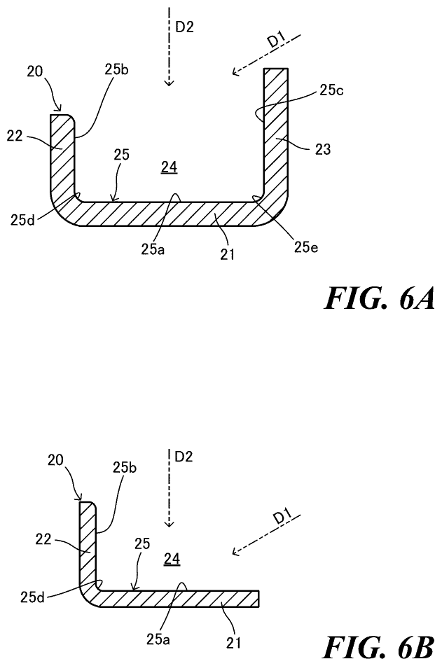

Hereinafter, a sealing device according to an embodiment of the present invention is explained below with reference to accompanying drawings of FIG. 1, FIG. 2A, FIG. 2B, FIG. 3A, FIG. 3B, FIG. 4A to FIG. 4D, FIG. 5A to FIG. 5C, FIG. 6A and FIG. 6B.

First, based on FIG. 1, a schematic basic configuration of a bearing device 1 to which sealing devices 10, 11 are attached is explained. In the description, as illustrated in FIG. 1, a side towards a wheel, not illustrated, along the direction of the rotation axis L, hereinafter abbreviated as the axial direction, i.e., the left side of FIG. 1, is referred to as a wheel side; a side towards a vehicle body, not illustrated, i.e., the right side of FIG. 1, is referred to as a vehicle body side.

In the bearing device 1 of FIG. 1, an outer ring member 2 is fixed to the vehicle body, not illustrated, two rows of rolling elements 7 are arranged inside thereof, and a hub wheel 3b and an inner ring 3a are rotatably supported around the axial center further inside thereof. The hub wheel 3b includes a hub flange 3c, and a drive wheel, not illustrated, and is mounted on the hub flange 3c by a bolt 3d and a nut, not illustrated.

A drive shaft 4 is coaxially spline-fitted to the hub wheel 3b, and the drive shaft 4 is connected to a drive source, not illustrated, via a constant velocity joint 5. The drive shaft 4 is integrated with the hub wheel 3b by a nut 4a, and thereby the hub wheel 3b is prevented from falling off from the drive shaft 4.

An inner ring member 3 is constituted by the hub wheel 3b and the inner ring 3a. The inner ring member 3 is allowed to rotate relatively with respect to the outer ring member 2 around the rotation axis L. The rolling elements 7 are interposed between the inner ring member 3 and the outer ring member 2 while being held respectively by retainers 7a.

Thus, two members rotating relatively are constituted by the outer ring member 2 and the inner ring member 3, and an annular space being a space which includes an interposed part of the rolling elements 7 is formed between the two members. The annular space is a bearing space and is a sealed space 6.

At an end portion on the vehicle body side in the axial direction of the sealed space 6, the sealing device 10 is attached. Further, at an end portion on the wheel side of the sealed space 6, another sealing device 11 is attached. Thus, by attaching the sealing devices 10, 11 respectively at both end portions, both end portions in the axial direction of the sealed space 6 are sealed.

The sealed space 6 is filled with lubricant such as grease, not illustrated; thereby, rolling of the rolling elements 7 is smoothly performed. The sealing devices 10, 11 not only prevent outside leakage of the lubricant but also have a function of preventing intrusion of muddy water, dust, or the like into the sealed space 6 from the outside, and have a function of discharging muddy water or the like which has intruded.

Additionally, on a face on a vehicle body side of a slinger 20A of the sealing device 10 which is mounted on the vehicle body side, an annular magnetic encoder, i.e., an annular magnet 27, is arranged, referring to FIG. 2A and FIG. 2B; a magnetic sensor 15 is installed on the vehicle body side at a position opposite to the annular magnet 27. Moreover, the slinger 20A is not always required to have the annular magnet 27.

The annular magnet 27 is an elastic member which is made by mixing and kneading magnetic powder into a rubber material and is integrally molded with the slinger 20A (a slinger body 20) to be mentioned later, and has a number of N poles and S poles alternatively magnetized along the circumferential direction thereof. The magnetic sensor 15 detects a magnetic change in accordance with rotation of the annular magnet 27. In other words, a rotation detection mechanism of the wheel, i.e., the inner ring member 3, is constituted by the magnetic sensor 15 and the annular magnet 27, thereby constituting an anti-lock brake system.

Next, the sealing device 10, on the vehicle body side, according to the present embodiment is explained below with reference to FIG. 2A and FIG. 2B. First, a schematic basic configuration of the sealing device 10 is described.

The sealing device 10 is an annular sealing device 10 which includes a core member portion 30A to be fitted and fixed to one of two members which relatively rotate in a concentric manner and the slinger 20A to be fitted and fixed to the other of the two members and which is constituted to seal a space between the two members.

The core member portion 30A includes a seal lip portion 35 which performs relative rotational motion while being in contact with the slinger 20A and which is made of an elastic material.

The slinger 20A includes a first cylindrical portion 22, a disk portion 21, and a second cylindrical portion 23; the slinger 20A has a recessed space 24 as an outer frame which is defined by the first cylindrical portion 22, the disk portion 21, and the second cylindrical portion 23. At least two continuous faces, i.e., the first face 25a of the disk portion 21 and the second face 25b of the disk portion 21 are roughened, the first face 25a facing the recessed space 24, the second face 25b being adjacent to the first face 25a.

In an example of the present embodiments to be explained below, one of the two members which relatively rotate in the concentric manner is the outer ring member 2 which is a fixed side member; the other member is the inner ring member 3 which is a rotation side member.

An inner face 25 of the slinger 20A includes a third face 25c, which faces the recessed space 24, of the second cylindrical portion 23.

Next, two examples of the sealing devices 10 illustrated in FIG. 2A and FIG. 2B are explained in detail. First, common configuration in the sealing devices 10 of FIG. 2A and FIG. 2B are explained.

In both of the sealing device 10, the slinger 20A is fitted and fixed to the inner ring member 3; the core member portion 30A is fitted and fixed to the outer ring member 2. The slinger 20A and the core member portion 30A are both annular member; in the slinger 20A, a sectional end face in the radial direction is formed in a U shape; in the core member portion 30A, a sectional end face in the radial direction is formed in an L shape; the slinger 20A and the core member portion 30A are mounted in the sealed space 6 of the bearing device 1 so as to be adjacent to each other.

The slinger 20A includes the slinger body 20 made of metal and the above-mentioned annular magnet 27 which constitutes the magnetic encoder.

The slinger body 20 includes the first cylindrical portion 22 which is fitted to the inner ring member 3, the disk portion 21 which extends radially outward from an outer end portion in the axial direction of the first cylindrical portion 22, and the second cylindrical portion 23 which extends axially inward from an outer end portion in the radial direction of the disk portion 21.

The recessed space 24 is an annular space which is surrounded by the first cylindrical portion 22, the disk portion 21, and the second cylindrical portion 23. Further, the slinger body 20 can be made of a hard synthetic resin material.

Size relation between protrusion dimensions of the first cylindrical portion 22 and the second cylindrical portion 23 from the disk portion 21 is not particularly specified; however, considering that the first cylindrical portion 22 is a fitting-related area, that the slinger 20A is combined with the core member portion 30A as illustrated in FIG. 2A and FIG. 2B, and that a roughening method described later, referring to FIG. 3A and FIG. 3B, is used in a manufacture process of the slinger 20A, the protrusion dimension of the first cylindrical portion 22 is preferably made greater; the protrusion dimension of the second cylindrical portion 23 is preferably made smaller than the protrusion dimension of the first cylindrical portion 22, as exemplified in the figures.

Among the inner faces 25 of the slinger 20A, the first face 25a is an axially inward face of the disk portion 21; the second face 25b is a radially outward face of the first cylindrical portion 22; the third face 25c is a radially inward face of the second cylindrical portion 23; and the above-mentioned three faces face the recessed space 24.

The annular magnet 27 is fixed to the disk portion 21 and the second cylindrical portion 23 so as to almost entirely cover both outer faces, i.e., faces on the vehicle body side, of the disk portion 21 and the second cylindrical portion 23. Further, the magnetic sensor 15 is arranged so as to face the disk portion 21 of the annular magnet 27.

The core member portion 30A is made by integrally fixing the seal lip portion 35 made of an elastic material such as rubber to a core body 30 made of metal. The core body 30 includes a core body cylindrical portion 32 which is fitted to the outer ring member 2 and a core body disk portion 31 which extends from an axially inward end portion of the core body cylindrical portion 32 into inward in the radial direction. Further, the core body 30 can be made of a hard synthetic resin material.

The seal lip portion 35 includes a seal body portion 35a which is fixed to the entire surface on an internal corner side between the core body cylindrical portion 32 and the core body disk portion 31, a first lip piece 35b which constitutes an axial lip, and a second lip piece 35c which constitutes a radial lip. Further, the seal body portion 35a is fixed so as to wrap around an outer face of the core body disk portion 31, i.e., an axially inward face, at a radially inward end portion 31a of the core body disk portion 31, and is also fixed so as to wrap around a radially outward face at an axially outward end portion 32a of the core body cylindrical portion 32.

The first lip piece 35b protrudes from the core body disk portion 31 side towards the first face 25a in an inclined state so as to increase the diameter and head outward in the axial direction; on the other hand, the second lip piece 35c protrudes from the core body disk portion 31 side towards the second face 25b in an inclined state so as to decrease the diameter and head inward in the axial direction.

In a state in which the sealing device 10 of FIG. 2A is mounted in the sealed space 6 of the bearing device 1, the first lip piece 35b elastically contacts the first face 25a, while the second lip piece 35c is in non-contact with the second face 25b. Meanwhile, the diagram with a two-dot chain line of the first lip piece 35b is a state diagram before elastic deformation.

In a state in which the sealing device 10 of FIG. 2B is mounted in the sealed space 6 of the bearing device 1, the first lip piece 35b is in non-contact with the first face 25a, while the second lip piece 35c elastically contacts the second face 25b. Further, the diagram with a two-dot chain line of the second lip piece 35c is a state diagram before elastic deformation.

In the embodiment, in either of such two types of the sealing devices 10, the two continuous faces of the first face 25a and the second face 25b are roughened. Specifically, the almost entire surface of the two continuous faces including a first internal corner portion 25d which is an internal corner on both faces is continuously roughened. Further, a second internal corner portion 25e which is an internal corner of the first face 25a and the third face 25c is also preferably roughened.

In general, when the lip pieces 35b, 35c slidably contact the slinger 20A by elastic contact, if a degree of adhesion is high, torque required for rotation of a rotation member needs to be increased. Therefore, by roughening the first face 25a and the second face 25b of the slinger 20A in order to avoid an increase in torque, the degree of adhesion is preferably lowered by avoiding so-called full surface contact of the lip pieces 35b, 35c with the slinger 20A.

As the roughened surface is used for such purposes, the first face 25a and the second face 25b which are continuous are preferably roughened continuously in the circumferential direction. Further, the first face 25a is preferably roughened continuously in the radial direction; the second face 25b is preferably roughened continuously in the axial direction.

In addition, the roughened surface can be constituted by an uneven pattern such as a pearskin or satin finish; that is, a concave part and a convex part can be discontinuous; however, needless to say, areas with which the lip pieces 35b, 35c are in contact are required not to be smooth.

According to the slinger 20A of the embodiment, since a roughened area in the slinger 20A covers a wide range of the two continuous faces, various shapes and specifications of the core member portions 30A, particularly, the lip pieces 35b, 35c of the seal lip portion 35, are combined with the slinger 20A.

That is, the slinger 20A is applicable to the core member portions 30A which has various lip pieces 35b, 35c including the two examples of FIG. 2A and FIG. 2B. Further, in such a slinger 20A, the first internal corner portion 25d can also be a contact position of the lip pieces 35b, 35c.

In other words, if the approximately entire surfaces of the first face 25a and the second face 25b are roughened, the contact position of the first lip piece 35b is matched with any position in the radial direction of the first face 25a, and the contact position of the second lip piece 35c is matched with any position in the axial direction of the second face 25b.

Further, in the slinger 20A of the present embodiment, since a wider range of the face is roughened so as to further include the second internal corner portion 25e, the first lip piece 35b which comes into contact with the second internal corner portion 25e can be provided.

Furthermore, if the first face 25a and the second face 25b include an area which is not roughened, there is a fear of an increase in torque; however, since the approximately entire surfaces of the first face 25a and the second face 25b are already roughened, the increase in torque is thereby suppressed.

Moreover, even when the first lip piece 35b and the second lip piece 35c are both for sliding contact, the so-called full surface contact is suppressed in either of the lip pieces 35b, 35c by the roughened surface. Therefore, collapse of internal pressure balance such that a closed space formed by the slinger 20A, the first lip piece 35b, and the second lip piece 35c becomes negatively pressurized is also prevented.

As to a roughened degree of the first face 25a and the second face 25b, according to various experiments by the present inventors, arithmetic mean roughness Ra which serves as an indicator of surface roughness is preferably 0.4 or more and 0.9 or less.

Next, a production method of the sealing device which includes the roughening method of the slinger 20A is explained. First, general basic steps of the production method according to the present embodiment are described with reference to FIG. 3A and FIG. 3B.

The production method includes at least a surface treatment step by collision of a projection material 41, illustrated with a two-dot chain line along with an arrow in FIG. 3A and FIG. 3B, against the slinger 20A (the slinger body 20).

As mentioned above in FIG. 2A and FIG. 2B, the sealing device 10 is constituted in such a manner that the core member portion 30A includes the seal lip portion 35 which performs relative rotational motion in contact or non-contact with the slinger 20A and which is made of an elastic material, that the slinger 20A includes the first cylindrical portion 22 which performs fitting to either of the two members, i.e., the outer ring member 2 and the inner ring member 3, and the disk portion 21, and that the slinger 20A has the recessed space 24 as the outer frame which is defined by the first cylindrical portion 22 and the disk portion 21 and which faces the core member portion 30A.

The surface treatment step is a process of projecting the projection material 41 on a face of the slinger 20A on the recessed space 24 side at different projection angles.

Next, a detailed process of the surface treatment step in the production method according to the present embodiment is explained with reference to FIG. 3A, FIG. 3B, and FIG. 4A to FIG. 4D. In examples of FIG. 3A and FIG. 3B, multiple types of projection steps are carried out in the process: two types of projection steps of a first projection step and a second projection step are exemplified as the projection step.

In the above-mentioned surface treatment step, shot blasting including shot peening, for example, is used as the roughening method of the slinger 20A (the slinger body 20) using the projection material 41. In the roughening method, a projection device 40 which projects the projection material 41 onto an object face is used.

As the projection material 41, various materials such as metal, ceramic, and the like can be adopted; spherical particles, powders, or the like is exemplified as a shape thereof; and various sizes are also employed. As for the projection device 40, a mechanical type, an air type, and a wet type are exemplified. As illustrated in FIG. 3A and FIG. 3B, the projection device 40 is provided to project the projection material 41 from various directions at a predetermined projection speed.

The roughening of the slinger body 20 by the projection of the projection material 41 is a treatment which is mainly performed on the first face 25a and the second face 25b; the projection device 40 is used by being installed at an appropriate position so as to allow the projection of the projection material 41 in various directions. Needless to say, an area of the object surface with which the projection material 41 projected by the projection device 40 collides varies based on a range of an ejection angle or a distance from the projection device 40 to the object face.

Further, since the roughening is performed mainly on the first face 25a and the second face 25b of the slinger body 20, the surface treatment step is preferably performed in such a manner that the slinger body 20 is placed on a workbench 45 with the outer face of the disk portion 21 facing downward and the recessed space 24 faces upward, as illustrated FIG. 3A and FIG. 3B. In FIG. 3A and FIG. 3B, an example of performing on the slinger body 20 to which the annular magnet 27 is not fixed is illustrated; however, the surface treatment step can be performed on the slinger 20A after the annular magnet 27 is fixed to the slinger 20A.

Furthermore, the surface treatment step (the roughening method) is a process in which the first projection step (refer to FIG. 3A) and the second projection step (refer to FIG. 3B) are combined. In the present roughening method, as illustrated in these figures, the projection device 40 is installed at two different positions (on the first face 25a and the second face 25b) against the slinger body 20.

Thus, in the surface treatment step, upon sequentially carrying out the first projection step and the second projection step, positional relation between the slinger body 20 and the projection device 40 is differed.

Moreover, since the slinger body 20 is an annular body, the first face 25a and the second face 25b need to be entirely roughened in the circumferential direction, and relative positional relation between the slinger body 20 and the projection device 40 needs to be variable.

Therefore, the projection material 41 can be designed to be projected while fixing the projection device 40 and rotating the slinger body 20 around the central axis thereof; or the projection material 41 can be designed to be projected by fixing the slinger body 20 and rotating the projection device 40 around the central axis of the slinger body 20.

Next, the first projection step and the second projection step which are sub-steps in the surface treatment step is each explained.

In the surface treatment step, although both of the first projection step and the second projection step need to be carried out, either step can be carried out first. Further, after carrying out both projection steps, based on a judgement from a result of the roughening or the like, either projection step or both projection steps can be carried out. Furthermore, both projection steps can be carried out simultaneously.

As illustrated in FIG. 3A, the first projection step is a step of projecting the projection material 41 from an opposed position on the recessed space 24 side of the second face 25b toward the first internal corner portion 25d and the vicinity thereof, i.e., the vicinity on a first cylindrical portion side and on a disk portion side, at an angle of more than 10 degrees and less than 40 degrees relative to the radial direction of the first face 25a.

That is, the projection device 40 is only required to be installed in an inclined state toward an inner part, not toward an outer part, of the first cylindrical portion 22 of the slinger body 20 within a range of the above-mentioned upper and lower limit angles.

The projection angle is preferably within the range of the above-mentioned upper and lower limit angles, but is only required to be determined considering various conditions such as the protrusion dimension of the first cylindrical portion 22, the protrusion dimension of the second cylindrical portion 23, a radial dimension of the disk portion 21, specifications of the projection device 40, an installation height of the projection device 40, or the like; therefore, the projection angle is allowed to be beyond the above-mentioned upper and lower limit angles.

As mentioned above and illustrated in FIG. 3A, since the protrusion dimension of the second cylindrical portion 23 from the disk portion 21 is smaller than the protrusion dimension of the first cylindrical portion 22, the projection device 40 is only required to be installed so that the projection material 41 projected from the projection device 40 passes above an opening side end portion of the second cylindrical portion 23. Installed as above, the projection material 41 is prevented from colliding with the outer face of the second cylindrical portion 23, thereby reducing waste of the projection material 41.

In the first projection step, the above-mentioned condition is preferably considered and adjusted so that the projection material 41 directly collides with the first internal corner portion 25d, the almost entire surface of the second face 25b, and a part of the first face 25a on the first internal corner portion 25d side.

As illustrated in FIG. 3B, the second projection step is a step of projecting the projection material 41 toward the first face 25a at an angle of more than 80 degrees and less than 100 degrees relative to the radial direction of the first face 25a, preferably at approximately 90 degrees. Further, the installation height of the projection device 40 is only required to be adjusted considering a spread degree of the projection material 41 of the projection device 40 or a radial linear dimension of the disk portion 21.

The projection angle is preferably within the range of the above-mentioned upper and lower limit angles; however, the projection angle is only required to be determined considering various conditions, namely, the protrusion dimension of the first cylindrical portion 22, the protrusion dimension of the second cylindrical portion 23, the radial linear dimension of the disk portion 21, the specification of the projection device 40, and the installation height of the projection device 40; therefore, the projection angle can be beyond the above-mentioned upper and lower limit angles.

In the second projection step, the projection material 41 is preferably adjusted considering the above-mentioned conditions so as to collide with the approximately entire surface of the first face 25a, the first internal corner portion 25d, at least a lower part of the second face 25b, the second internal corner portion 25e, and at least a lower part of the third face 25c.

In both of the first projection step and the second projection step, an experiment shows that the projection materials 41 projected with a time lag sometimes collide with each other when each projection step is carried out for a predetermined time. For example, in the same projection step, the projection material 41 which is projected antecedently and bounces back after colliding with the inner face 25 and the projection material 41 which is projected thereafter collide with each other, and the projection materials collided with each other may collide at various areas while changing the direction. Needless to say, there is a possibility that, due to a bounce by the collision of the projection material 41 against the inner face 25, the projection material 41 collide with the inner face 25 again.

Further, in order to make the surface roughness appropriate one, namely, in order that the arithmetic mean roughness Ra is 0.4 or more and 0.9 or less, projection time and projection speed are only required to be determined for obtaining an appropriate slinger body 20 by suitably changing and adjusting the projection time or the projection speed in each of the first projection step and the second projection step so that the arithmetic mean roughness Ra falls within such ranges.

Thus, by combining and carrying out the first projection step and the second projection step, the inner face 25 of the slinger 20A with which the lip pieces 35b, 35c are slidably in contact is roughened throughout a wide range. Regardless of the shape and the specification of the seal lip portion 35 of the core member portion 30A to be combined with the slinger 20A, a wide area of the inner face 25 of the slinger 20A is roughened, thereby enhancing design flexibility of the sealing device 10.

As for the combination of the projection steps, three or more types of projection steps can be combined; however, the projection step such as the first projection step in which the projection material 41 is projected obliquely toward the vicinity of the first internal corner portion 25d by inclining the projection device 40 is preferably included at least. Further, the projection step from radially inward toward position the second internal corner portion 25e in the outward direction can be included.

Further, according to such a roughening method, the wide range of the inner face 25 of the slinger 20A is found to be roughened almost uniformly. Also, by such uniformization, the flexible design of the sealing device 10 is promoted.

Furthermore, according to such a roughening method, the wider face is uniformly roughened only by combining the first projection step and the second projection step; therefore, the need for various further processing for uniformization is reduced, thereby achieving effective production of the slinger 20A.

Furthermore, even if the contact positions of the lip pieces 35b, 35c against the slinger body 20 at the time of mounting the sealing device 10 on the bearing device 1 are not as expected, as long as the inner face 25 of the slinger body 20 is uniformly roughened, possibility of change in rotational torque due to the unexpected contact positions is low. Therefore, adjustment at the time of mounting the sealing device 10 or need for replacement of the slinger 20A is reduced, thereby carrying out efficient work.

Moreover, even if the slinger 20A is in the U shape as in the sealing device 10 of the present embodiment, the first projection step and the second projection step are carried out without any problems. Since the first projection step is performed with the projection device 40 inclined, the projection material 41 may not collide with a part of the first face 25a; however, since the second projection step is also carried out, the part which is not roughened by the first projection step is complemented by the second projection step.

In particular, experiments reveal that an outer part of the first face 25a and the vicinity of the second internal corner portion 25e, which are conventionally considered to be the most difficult area to be roughened, of the inner face 25 of the slinger 20A were roughened to substantially the same degree as the inner and central parts of the first face 25a.

As to the wide range roughening and uniformity thereof, the inventors carried out the combination of the first projection step and the second projection step as an example of the present embodiment, and the inventors measured respective surface roughness values, i.e., the arithmetic mean roughness Ra, of the first face 25a and the second face 25b using a surface roughness measuring instrument, not illustrated, for the roughened inner face 25 of the slinger body 20. Additionally, comparative experiments were conducted for a comparative example to the example of the present embodiment, thereby measuring the arithmetic mean roughness Ra.

Specifically, the number of experiment objects, i.e., the number of a sheet of the slinger body 20, of the example in the present embodiment and the comparative example was each set to 30; experiments were conducted for each of the first face 25a and the second face 25b at the following projection angles; and an average value of the arithmetic mean roughness Ra was calculated.

### Projection Angle

Example of the present embodiment: Projection at a projection angle of 90 degrees, i.e., the second projection step, and projection at a projection angle of 30 degrees, i.e., the first projection step, were carried out.

Comparative Example: Projection at a projection angle of 45 degrees was carried out twice.

Then, for the example in the present embodiment and the comparative example, the arithmetic mean roughness Ra was measured under the following measurement conditions by operating an inspection needle of the measuring instrument, Surfcorder SE3500 manufactured by Kosaka Laboratory Ltd., on each of the first face 25a and the second face 25b of the slinger body 20 of which surface was roughened. Operation direction of the inspection needle was circumferential for both of the first face 25a and the second face 25b.

### Measurement Method and Conditions

The measurement method and conditions were based on the standard “JIS B 0601:2001” which relates to evaluation of surface roughness.

Specific conditions were set as follows:
Length of measurement of the arithmetic mean roughness Ra: 2.4 mm (the length being approximately ten percent of length in the circumferential direction)
Measurement speed of the inspection needle: 0.1 mm/sec

Results of the experiment and the measurement are explained below with reference to FIG. 4A to FIG. 4D.

Measurement of the first face 25a in the circumferential direction was performed in such a manner that, in one appropriate circular arc portion in the circumferential direction, an appropriate measurement point was selected from each area of an inner portion A, a center portion B, and an outer portion C which are illustrated in FIG. 4A, and the inspection needle was linearly operated so as to substantially align with the circumferential direction at the measurement point.

The inner portion A, the center portion B, and the outer portion C illustrated in FIG. 4A are three areas which were provided by virtually and almost uniformly dividing the radial linear dimension of the first face 25a into three parts. In the sealing device 10 of FIG. 2A and FIG. 2B, the center portion B, and the outer portion C are main areas to which the first lip piece 35b may contact or come close.

Further, inspection of the second face 25b in the circumferential direction was performed in such a manner that an appropriate measurement point was selected in one appropriate circular arc portion, which can be the same circular arc portion as the first face 25a, in the circumferential direction, and the inspection needle was operated so as to approximately align with the circumferential direction at the measurement point. The measurement position in the experiment was selected from an area D which was an area to which the second lip piece 35c contacted or came close and was along the axial direction, referring to FIG. 4A.

As for a measurement procedure, in either case of the example of the present embodiment or the comparative example, the arithmetic mean roughness Ra was each measured at three sports of the first face 25a and at one spot of the second face 25b; such measurement was repeated “n” times, “n” being the number of the sheets, i.e., 30 sheets, thereby calculating an average value for “n” sheets.

Next, a ratio, i.e., a relative value, of arithmetic mean roughness Ra of each portion, i.e., the inner portion A, the center portion B, the outer portion C, and the area D, to the arithmetic mean roughness Ra of the center portion B was calculated. Namely, the arithmetic mean roughness Ra of each portion divided by the arithmetic mean roughness Ra of the center portion B was calculated.

In other words, as to the roughening in the present embodiment, instead of comparing the absolute value of the arithmetic mean roughness Ra, the relative value of the arithmetic mean roughness Ra of each portion was calculated based on a standard value of 1.0 for the arithmetic mean roughness Ra of the center portion B, and various comparisons were made for evaluation and judgement.

The table in FIG. 4B represents the relative value of each portion for the example of the present embodiment in which the surface treatment was performed in the order of the second projection step (90 degrees) and then the first projection step (30 degrees). The table shown in FIG. 4C represents the relative value of each portion for the comparative example in which the surface treatment was performed by carrying out the projection at 45 degrees two times.

In the relative value of each portion in the present embodiment, the minimum value was 0.91 (the inner portion A) and the maximum value was 1.04 (the outer portion C and the area D); while, in the relative value of each portion in the comparative example, the minimum value was 0.69 (the outer portion C) and the maximum value was 1 (the center portion B), referring to FIG. 4B and FIG. 4C. The above-mentioned relative values revealed that the present embodiment was better evaluated and judged to achieve the uniformity than the comparative embodiment.

In particular, regarding the outer portion C and the area D, as is apparent from the numerical value in FIG. 4D, the uniformity was greatly improved as compared with the conventional roughening method, i.e., the comparative example. FIG. 4D shows the ratio of the example of the present embodiment based on the numerical value of the comparative example, i.e., the value of the example of the present embodiment divided by the value of the comparative example, was calculated for the arithmetic mean roughness Ra of each portion. As shown in such relative value table, the relative value of the outer portion C was 1.30, which shows an improvement in a degree of the roughening of the outer portion C; the relative value of the area D was 1.25, which shows an improvement in a degree of the roughening of the area D.

The inventors also focused on a fact that the relative value of the outer portion C which was conventionally considered difficult to be roughened was greater than the relative value of the inner portion A, referring to FIG. 4B, and determined that the difference of 0.25 or less was an acceptance criterion regarding the roughening of the outer portion C. Furthermore, if the difference exceeded 0.25, the inventors determined that such difference was inappropriate for the uniformity and was considered to be a failure.

Further, the inventors determined the fact that the relative value of the area D (the second face 25b) was greater than the relative value of the inner portion A was an acceptance criterion regarding the roughening of the area D (the second face 25b). In particular, the relative value of the area D is preferably 0.85 or more and 1.15 or less.

As shown from the above-mentioned experimental results, combining the first projection step and the second projection step was determined to be appropriate for the roughening method of the inner face 25 of the slinger 20A.

Next, an application example of the slinger 20A (the slinger body 20) of another shape according to the production method of the sealing device of the present embodiment is explained with reference to FIG. 5A to FIG. 5C, FIG. 6A and FIG. 6B. In the figure, D1 is projection direction of the projection material 41 in the first projection step, and D2 is projection direction of the projection material 41 in the second projection step.

The slinger body 20 illustrated in FIG. 5A has the first internal corner portion 25d which is not in a curved shape but is in a planar shape which is upwardly inclined from the disk portion 21 toward the first cylindrical portion 22. In the second cylindrical portion 23, the protrusion degree thereof is smaller than that of the first cylindrical portion 22.

The slinger body 20 illustrated in FIG. 5B has the first internal corner portion 25d which is curved with a greater radius than the first internal corner portion 25d of the slinger 20A illustrated in FIG. 2A and FIG. 2B. In the second cylindrical portion 23, the protrusion degree thereof is smaller than that of the first cylindrical portion 22.

The slinger 20A illustrated in FIG. 5C has the first internal corner portion 25d which is not in the curved shape but is in an upwardly inclined shape from the disk portion 21 toward the first cylindrical portion 22. In the second cylindrical portion 23, the protrusion degree thereof is smaller than that of the first cylindrical portion 22; the second cylindrical portion 23 is inclined so as to fall down towards an opposite side to the recessed space 24 side.

By combining the first projection step and the second projection step, the wide range of surface which faces the recessed space 24 of the slinger body 20 is roughened. In particular, in the slinger body 20 of FIG. 5C, since the second cylindrical portion 23 has an inclined shape and the recessed space 24 expands radially upward, the projection of the projection material 41 in the first projection step is facilitated.

Further, in the slinger body 20 illustrated in FIG. 6A, the protrusion degree of the second cylindrical portion 23 is greater than the protrusion degree of the first cylindrical portion 22. In such a shape, although the projection area of the projection material 41 by the first projection step becomes smaller, roughening of a wider area and the uniformity of the roughening are complemented by executing the second projection step.

Further, the first face 25a, the second face 25b, and the first internal corner portion 25d are easily roughened by the first projection step and the second projection step, since the slinger body 20 of FIG. 6B is in an L shape and does not have the second cylindrical portion 23. Since the slinger body 20 does not have the second cylindrical portion 23, the projection angle of the first projection step can be about 10 degrees.

As to FIG. 5A to FIG. 5C, and FIG. 6A, since the slinger body 20 is in a U shape, these examples are applicable to the sealing device 10 of FIG. 2A and FIG. 2B using the slinger body 20 in a U shape.

Although the sealing device 10 on the vehicle body side is explained above, the above-mentioned structure of the sealing device 10 is also applicable to other sealing devices 11 on the wheel side. Needless to say, the above-mentioned production method (the roughening method) is applied to the sealing devices 10, 11 on both of the vehicle body side and the wheel side.

Although the above-mentioned embodiments exemplify the sealing devices 10, 11 in which a fixed member 2 is the outer ring member and a rotation member 3 is the inner ring member, the present invention is also applicable to a sealing device in which the fixed member 2 is the inner ring member and the rotation member 3 is the outer ring member.

The sealing device 10 related to the above-mentioned embodiments is merely one example, and other appropriate examples are also acceptable. Needless to say, the entire shape of the sealing device 10 can be changed as a design matter, as needed.

Further, the production method of the sealing device according to the present embodiment is merely one example, and others are also acceptable. Also, as to the projection device 40, various structures can be applied.

### DESCRIPTION OF THE REFERENCE NUMERAL

1 bearing device
2 fixed member (outer ring member)
3 rotation member (inner ring member)
3a inner ring
3b hub wheel
6 sealed space
10 sealing device
11 sealing device (another sealing device)
20A slinger
20 slinger body
21 disk portion
22 first cylindrical portion
23 second cylindrical portion
24 recessed space
25 inner face
25a first face
25b second face
25c third face
25d first internal corner portion
25e second internal corner portion
30A core member portion
30 core body
31 core body disk portion
32 core body cylindrical portion
35 seal lip portion
35a seal body portion
35b first lip piece
35c second lip piece
40 projection device
41 projection material
A inner portion (of first face)
B center portion (of first face)
C outer portion (of first face)
D area (to which the second lip piece on the second face contacts or is adjacent)

1. A sealing device comprising:
a core member portion to be fitted and fixed to one of two members which relatively rotate in a concentric manner; and
a slinger to be fitted and fixed to another of the two members,
the sealing device being configured to seal a space between the two members and being in an annular shape,
wherein the core member portion comprises a seal lip portion which performs relative rotational motion while being in contact with the slinger and is made of an elastic material,
wherein the slinger comprises a first cylindrical portion, a disk portion, and a second cylindrical portion which are provided for fitting, and comprises a recessed space as an outer frame which is defined by the first cylindrical portion, the disk portion, and the second cylindrical portion, and
wherein at least two continuous faces of a first face of the disk portion and a second face of the disk portion are roughened, the first face facing the recessed space, the second face being adjacent to the first face.

2. The sealing device according to claim 1,
wherein an approximately entire surface, including an internal corner portion, of both faces of the two continuous faces is continuously roughened.

3. The sealing device according to claim 1,
wherein the second face is a face of the first cylindrical portion,
wherein the seal lip portion comprises a first lip piece facing the first face and a second lip piece facing the second face, and
wherein at least one of the first lip piece and the second lip piece elastically contacts with an object face at the relative rotational motion.

4. The sealing device according to claim 1,
wherein arithmetic average roughness of the first face and arithmetic average roughness of the second face are 0.4 or more and 0.9 or less.

5. The sealing device according to claim 1,
wherein the first face comprises three areas, an inner portion, a center portion, and an outer portion, which are formed by virtually dividing a linear dimension along radial direction in an approximately equal manner, and
wherein a ratio of arithmetic average roughness of the outer portion to arithmetic average roughness of the center portion is greater than a ratio of arithmetic average roughness of the inner portion to the arithmetic average roughness of the center portion, and a difference between the ratio of the arithmetic average roughness of the outer portion to the arithmetic average roughness of the center portion and the ratio of the arithmetic average roughness of the inner portion to the arithmetic average roughness of the center portion is 0.25 or less.

6. The sealing device according to claim 1,
wherein the first face comprises three areas, an inner portion, a center portion, and an outer portion, which are formed by virtually dividing a linear dimension along radial direction in an approximately equal manner, and
wherein a ratio of arithmetic average roughness of the second face to arithmetic average roughness of the center portion is greater than a ratio of arithmetic average roughness of the inner portion to the arithmetic average roughness of the center portion.

7. The sealing device according to claim 1,
wherein an internal corner portion between the first face and a third face of the second cylindrical portion is roughened.
